(19) United States
(12) Patent Application Publication
(10) Pub. No.: US 2006/0164540 A1
(43) Pub. Date: Jul. 27, 2006

(54) Zoom lens system and camera having the same

(76) Inventor: Yasuaki Kayanuma, Fujiyoshida-shi (JP)

Correspondence Address: BRINKS HOFER GILSON & LIONE, P.O. BOX 10395, CHICAGO, IL, 60610, US

(21) Appl. No.: 11/338,432

(22) Filed: Jan. 23, 2006

(30) Foreign Application Priority Data
Jan. 24, 2005 (JP) JP2005-014920

(51) Int. Cl. H04N 5/232; G03B 13/00

(52) U.S. Cl. 348/345

(57) ABSTRACT

A zoom lens system capable of changing the zoom magnification correctly with a single actuator has a magnification changing lens and a focusing lens aligned on an optical axis, a liquid crystal lens, an actuator for moving the magnification changing lens and the focusing lens along the optical axis, a cam mechanism set between the actuator and the magnification changing and focusing lenses, and a driver that applies a voltage to the liquid crystal lens to change the refractive index thereof. The cam mechanism is driven by the actuator to move the magnification changing lens and the focusing lens individually along the optical axis of the zoom lens system, thereby changing the zoom magnification. The driver adjusts the voltage applied to the liquid crystal lens to effect fine adjustment of the focus position.

This application claims priority under 35 U.S.C. §119 to Japanese Patent Application No. 2005-014920 filed Jan. 24, 2005, the entire content of which is hereby incorporated by reference.

### FIELD OF THE INVENTION

The present invention relates to camera modules and cameras for use in mobile cellular phones and so forth. More particularly, the present invention relates to a zoom unit for use in such camera modules and cameras to perform zooming.

### DESCRIPTION OF BACKGROUND ART

A zoom unit has at least two lenses, i.e. a magnification changing lens for changing the magnification of the zoom unit and a focusing lens for controlling the focus position. These lenses need to be moved individually to perform zooming. It should be noted that the terms “magnification changing lens” and “focusing lens” as used in this specification each include a lens system comprising a plurality of lens elements.

In general, the position of the focus varies according to the object distance. That is, the focus position for taking an image of an object at an infinite distance is different from that for imaging an object at a near distance. To compensate for the focus position variation, it is also necessary to move the magnification changing lens and the focusing (focus adjusting) lens.

FIGS. 3(a) and 3(b) show the positional relationship between a fixed lens 10, a magnification changing lens 12, a focusing lens 14 and a light-receiving IC 16. FIG. 3(a) shows the positional relationship when the zoom magnification is 2 times, for example, and the object is at an infinite distance. FIG. 3(b) shows the positional relationship when the zoom magnification is also 2 times and the object is at a near distance, e.g. 30 cm. Reference numeral 18 denotes an enclosure (lens barrel).

As shown in FIGS. 3(a) and 3(b), even when the magnification is the same, the position of focusing lens 14 needs to be moved between a and b according to the distance between the zoom unit and the object in order to make the focus position coincident with the light-receiving surface of the light-receiving IC 16.

FIG. 4 shows the position of each lens when the magnification is changed.

In FIG. 4, reference numeral 22 denotes the position of the fixed lens 10 when the magnification is changed to 1 time, 2 times and 3 times. Reference numeral 24 denotes the position of the magnification changing lens 12 that changes when the magnification is changed in the same way as the above. Reference numerals 26 and 28 denote the position of the focusing lens 14 that changes with the above-described magnification change. When the magnification changing lens 12 is changed as shown by the lens position 24 to change the magnification, the focusing lens 14 is moved to assume the lens position 26 that is uniquely determined relative to the lens position 24. For example, when the object is at an infinite distance, however, the focusing lens 14 needs to assume the position shown by reference numeral 28. When the object is at a near distance, e.g. 10 cm, the focusing lens 14 needs to assume the position shown by reference numeral 26.

Accordingly, the zoom unit requires an actuator for moving the magnification changing lens and another actuator for moving the position of the focusing lens.

FIG. 5 is a schematic view showing a conventional zoom unit.

The zoom unit has a fixed lens 10, a magnification changing lens 12, a focusing lens 14, and a light-receiving IC 16 that are positioned on an optical axis L of a lens barrel 18. A member 30 supporting the magnification changing lens 12 is moved by a first actuator 34, and a member 32 supporting the focusing lens 14 is moved by a second actuator 36.

From the viewpoint of achieving a compact zoom unit, however, it is desirable to minimize the number of actuators. Meanwhile, actuators are devices required to move precisely, and, therefore, expensive devices to be used. From the viewpoint of reducing costs, also, minimization of the number of actuators is desirable.

Meanwhile, a noteworthy technique has been developed recently.

That is, a novel lens that is known as “liquid crystal lens” has been proposed, in which a lens function is imparted to a liquid crystal cell formed from a pair of opposed flat plate-shaped substrates [for example, see Japanese Patent Application Unexamined Publication (KOKAI) No. Hei 6-130351].

There have also been proposed a diffraction type liquid crystal lens and a multifocal diffraction type liquid crystal lens capable of adjusting the focal length at high speed and exhibiting a high transmittance for incident light [for example, see Japanese Patent Application Unexamined Publication (KOKAI) No. 2002-357804].

Royal Philips Electronics released a compact and variable focal length liquid lens on Mar. 3, 2004.

The present invention was made to achieve a compact zoom unit by using the above-described liquid crystal lens or liquid lens capable of adjusting the focal length at high speed.

### SUMMARY OF THE INVENTION

Accordingly, an object of the present invention is to solve the above-described problem of the conventional zoom lens systems; because at least two actuators are required, it is difficult to achieve a size reduction, and costs increase undesirably.

The present invention provides a zoom lens system having one optical axis. The zoom lens system includes a magnification changing lens and a focus adjusting lens aligned on the optical axis. One of a liquid crystal lens and a liquid lens is aligned with the magnification changing lens and the focus adjusting lens on the optical axis. The zoom lens system further includes an actuator and a power transmission device drivably connected to the actuator and to the magnification changing lens and the focus adjusting lens. The power transmission device is driven by the actuator to move the magnification changing lens and the focus adjusting lens individually along the optical axis of the zoom lens system. A driver applies a voltage to the one of the liquid crystal lens and the liquid lens to change the refractive index thereof. In the zoom lens system, the actuator changes the magnification of the zoom lens system, and the driver adjusts the voltage applied to the one of the liquid crystal lens and the liquid lens, thereby finely adjusting the focus position of the zoom lens system.

The power transmission device may be a cam mechanism.

In addition, the present invention provides a camera having the above-described zoom lens system.

The zoom lens system according to the present invention requires only one actuator. Therefore, it becomes possible to reduce the size and costs of the zoom lens system and hence a camera or a camera module having the same and also to improve the ease of manufacture of these products.

Other objects and advantages of the present invention will become apparent from the following detailed description of illustrated embodiments of the invention.

### BRIEF DESCRIPTION OF THE DRAWINGS

FIG. 1 is a diagram showing the position of each lens in a zoom lens system according to the present invention that changes according to the zoom ratio.

FIG. 2 is a schematic view for explaining the arrangement of the zoom lens system according to the present invention.

FIG. 3a is a diagram for explaining the relationship between the distance from the zoom lens system to an object and the position of each lens of the zoom lens system when the object is at an infinite distance.

FIG. 3b is a diagram showing the relationship between the distance from the zoom lens system to an object and the position of each lens of the zoom lens system when the object is at a near distance.

FIG. 4 is a diagram showing the position of each lens in a conventional zoom lens system that changes according to the zoom magnification and the distance from the zoom lens system to an object.

FIG. 5 is a schematic view showing the arrangement of a conventional zoom lens system.

### DETAILED DESCRIPTION OF THE PREFERRED EMBODIMENTS

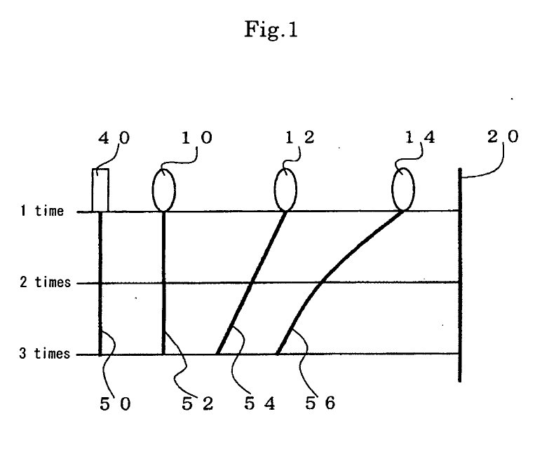

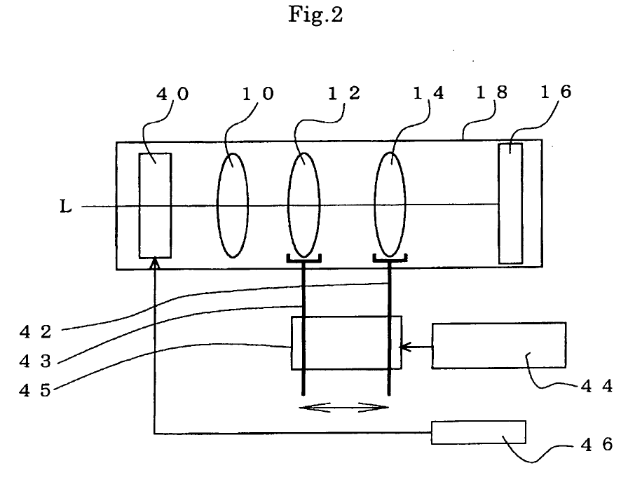

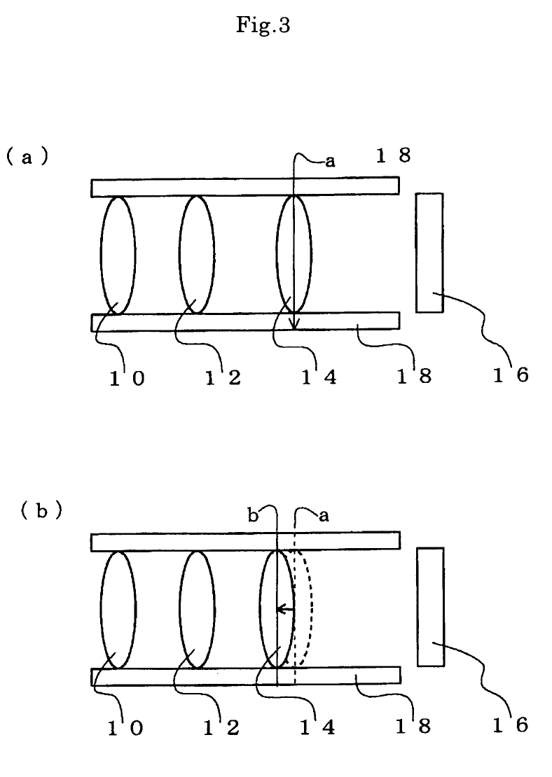

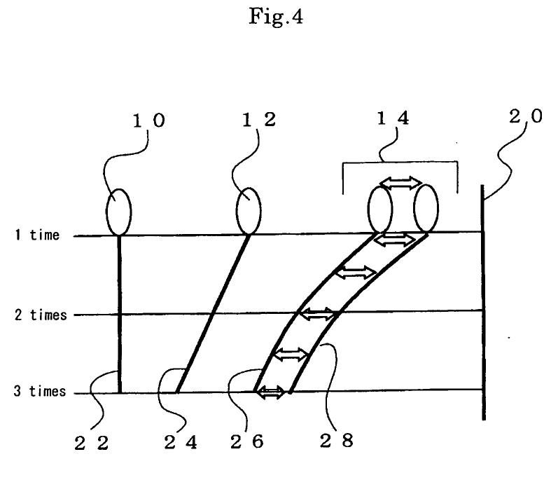

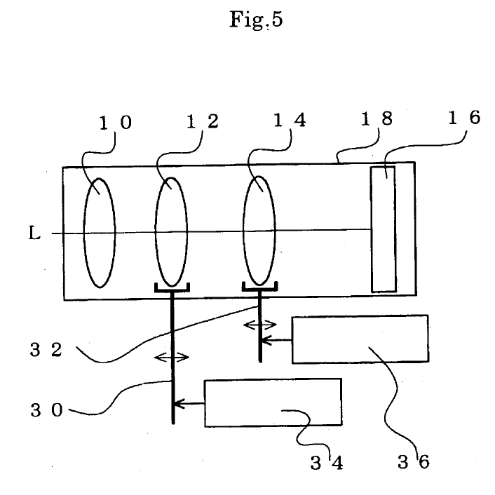

An embodiment of a zoom unit according to the present invention will be explained below with reference to FIGS. 1 and 2.

FIG. 2 is a schematic view showing a zoom lens system according to the present invention.

The zoom unit has a lens barrel 18. A liquid crystal lens 40, a fixed lens 10, a magnification changing lens 12, a focusing lens 14 and a light-receiving IC 16 are positioned along an optical axis L of the lens barrel 18. The zoom unit further has a magnification changing lens support member 43, a focusing lens support member 42, an actuator 44, a cam mechanism 45, and a liquid crystal lens driver 46. The cam mechanism 45 is set between the actuator 44 and the support members 42 and 43 to move the support members 42 and 43 to respective predetermined positions on the optical axis L according to driving force from the actuator 44. The position of the liquid crystal lens 40 is not necessarily limited to the position forward of the fixed lens 10. The liquid crystal lens 40 may be positioned between any pair of adjacent components, i.e. the fixed lens 10, the magnification changing lens 12, the focusing lens 14, and the light-receiving IC 16 (the position 20 thereof).

FIG. 1 shows a relationship between the position 50 of the liquid crystal lens 40, the position 52 of the fixed lens 10, the position 54 of the magnification changing lens 12 and position 56 of the focusing lens 14 when the magnification of the zoom unit according to the present invention is changed between 1 and 3 times.

That is, in the zoom unit according to the present invention, the cam mechanism 45 uniquely determines the position 56 of the focusing lens 14 on the optical axis L with respect to the displaced position 54 of the magnification changing lens 12 along the optical axis L.

When the magnification of the zoom unit is determined, the position of the focus is substantially coincident with the light-receiving surface 20 of the light-receiving IC 16. In order to position the focus on the light-receiving surface 20 even more precisely, however, it is necessary to make some correction based on the distance between the zoom unit and the object. In the zoom unit according to the present invention, the correction of the focus position is made by using the liquid crystal lens 40, not by moving the focusing lens 14 as in the above-described conventional zoom unit. The range of focus position adjustable with the liquid crystal lens is relatively small. It is, however, possible to compensate for the focus position displacement caused by a change from the close-up imaging position to the infinite distance imaging position.

More specifically, in the zoom unit according to the present invention, the magnification changing lens 12 and the focusing lens 14 are moved by the actuator 44 along the optical axis L to effect positional adjustment, thereby obtaining the desired magnification and making coarse adjustment of the focus position. Further, the liquid crystal lens 40 is controlled at high speed to effect fine adjustment of the focus position. In the focus position adjustment, the position of the focusing lens 14 is uniquely determined relative to the position of the magnification changing lens 12 by the cam mechanism 45. The relative positional relationship between the focusing lens 14 and the magnification changing lens 12 is determined by the characteristics of these lenses.

It should be noted that whether the light-receiving IC 16 and the liquid crystal lens driver 46 are provided in or outside the lens barrel 18 is a matter of design.

Although the above-described embodiment uses a liquid crystal lens by way of example, a liquid lens may be used to construct a zoom unit having the same function as the above. In the foregoing embodiment, the relative positional relationship between the focusing lens 14 and the magnification changing lens 12 is determined by a cam mechanism 45. It will, however, be apparent to those skilled in the art that the device for determining the above-described relative positional relationship is not necessarily limited to the cam mechanism.

As has been stated above, the zoom unit according to the present invention uses a liquid crystal lens or a liquid lens, thereby reducing the number of actuators required to only one, in contrast to the conventional zoom units, which require at least two actuators. Thus, the present invention offers a remarkable advantageous effect.

Because a zoom unit can be constructed by using only one actuator, it becomes possible to achieve a compact zoom unit, reduce costs and improve convenience for assembling.

It also becomes possible to reduce the size and cost of a camera using the above-described zoom unit.

It should be noted that the present invention is not necessarily limited to the foregoing embodiments but can be modified in a variety of ways without departing from the gist of the present invention.

Although the present invention has been described in terms of specific embodiments, it is anticipated that alternations and modifications thereof will no doubt become apparent to those skilled in the art. It is therefore intended that the following claims be interpreted as covering all such alternations and modifications as fall within the true sprit and scope of the invention.

1. A zoom lens system having an optical axis, comprising:
a magnification changing lens and a focusing lens aligned on said optical axis;
one of a liquid crystal lens and a liquid lens aligned with said magnification changing lens and said focusing lens on said optical axis;
an actuator;
a power transmission device drivably connected to said actuator and to said magnification changing lens and said focusing lens, said power transmission device being driven by said actuator to move said magnification changing lens and said focusing lens individually along the optical axis of said zoom lens system; and
a driver that applies a voltage to said one of said liquid crystal lens and liquid lens to change a refractive index thereof;
wherein said actuator changes a magnification of said zoom lens system, and said driver adjusts the voltage applied to said one of said liquid crystal lens and liquid lens thereby finely adjusting a position of a focus of said zoom lens system.

2. A zoom lens system according to claim 1, wherein said power transmission device is a cam mechanism.

3. A camera having said zoom lens system according to claim 1.

4. A camera having said zoom lens system according to claim 2.
